(19) United States
(12) Patent Application Publication
(10) Pub. No.: US 2003/0020926 A1
(43) Pub. Date: Jan. 30, 2003

(54) Tunable band pass optical filter unit with a tunable band pass interferometer

(76) Inventor: Nicolae Miron, Pierrefonds (CA)

Correspondence Address: GOODWIN PROCTER & HOAR LLP, 7 BECKER FARM RD, ROSELAND, NJ, 07068, US

(21) Appl. No.: 10/074,948

(22) Filed: Feb. 13, 2002

Related U.S. Application Data
(60) Provisional application No. 60/291,191, filed on May 15, 2001.

(51) Int. Cl. G01B 9/02

(52) U.S. Cl. 356/519

(57) ABSTRACT

A tunable band pass optical filter with tunable band-pass interferometer according to the present invention comprises a tunable band pass optical filter comprising a frame, at least one translation plate, at least one flexure element for mounting said at least one translation plate to said frame, a first mirror mounted to said at least one translation plate, a second mirror mounted to said frame in optical communication with said first mirror, having a distance between said first and said second mirror, at least one compensation screw operatively connected to said frame and said at least one translation plate; and at least one piezo-ceramic actuator operatively connected to said frame and said at least one translation plate.

Application Ser. No. 09/705,447, filed on Nov. 3, 2000 is incorporated herein by reference in its entirety. This application claims priority of Provisional Application No. 60/291,191, filed on May 15, 2001 which is incorporated herein by reference in its entirety.

### FIELD OF THE INVENTION

This invention relates to an optical band pass filter unit able to select its center wavelength within a specific wavelength range, further called tunable band pass optical filter (TBPOF) having as a wavelength selectable element a tunable band pass interferometer (TBPI) that is the subject of the U.S. patent application Ser. No. 09/705,447. The main application of TBPOF according to the present invention is in dense wavelength division and multiplexing (DWDM) technology for optical communications.

It is very well known to those skilled in the art that DWDM technology operates with multiple wavelengths, all of them using simultaneously the same monomode optical fiber as a propagation medium. From the optical communications standpoint, the term wavelength is used with the same meaning as an information channel and usually the terms wavelength and channel are interchanged, depending on the context. Each wavelength is a carrier for the modulating signal, which can be either an analog signal (voice, video), or a digital signal (data, digitized voice signal, digitized image signal, which are all denoted data). In all the presentation herein, it will be discussed only the aspects related to carrier wavelength, not to the modulating signal. Because DWDM technology makes it possible to combine and transmit multiple signals simultaneously at different wavelengths on the same optical fiber, optical networks can be scalable, adding carrier other tests are available wavelengths to the physical maximum of the fiber to carry as many signals as possible. Presently, the selection of wavelengths to include or exclude from an optical fiber is made by using components with transmission characteristics adjusted to fixed wavelengths such as arrayed waveguide gratings (AWG) or Bragg gratings (BG). Even if these devices would have perfect wavelength transfer characteristics in terms of wavelengths, they must be combined with optical switches (OSW) to make a device which functions for different input and output wavelengths. However, the use of OSW's introduce more insertion loss and increase system complexity and cost. A great advantage therefore would be to introduce a TBPOF, able to select at the output only one wavelength within a range available at its input. This will provide great flexibility at the (AON) level. Another major advantage derived from using a TBPOF would be the ability to select a single wavelength at the source (laser) side, and at the receiver side. Another advantage for the wavelength routing architecture of AON using TBPOF would be the ability to configure the network in terms of wavelength selection and wavelength cross-connect.

The demand for increased communication bandwidth has pushed DWDM technology to evolve very rapidly from the conventional (C) band between 1525 nm to about 1565 nm, toward the long (L) band range from about 1565 nm to about 1620 nm and eventually to the short (S) band from about 1400 nm to about. In addition, the 1310 nm region is used extensively by most of the optical networks operating today. Communication capacity can also be expanded by increasing the number of channels in each band. A problem with this approach is that it leads to tight separation between the channels, which can introduce cross talk between the channels due to the overlapping of the sidebands of adjacent channels. In terms of frequency, channel separation is accurately expressed by International Telecommunication Union (ITU) recommendation G.692, as 100 GHz, 50 GHz or 25 GHz grids. In terms of wavelength, these grids correspond to about 0.8 nm, 0.4 nm and 0.2 nm wavelength separation. The difficulties encountered due to channel separation and cross talk are important factors contributing to the bit error rate (BER) of a transmission from the standpoint of wavelength filtering. The ability to have close channel separation is achieved by the capability of the laser to generate very narrow and stable spectral lines or optical carriers, and by the capability of the receiver to separate the modulated carriers having attached the sidebands of the modulating signal. Channel separation at the receiver side is even more complicated to define than at the source side, due to effects induced during the propagation of the light into the optical fiber, some of the most significant include: four wave mixing (FWM), chromatic dispersion (CD) and polarization mode dispersion (PMD). The existing ITU recommendation G.692 specifies channel separation taking into account the existing technological capabilities at the moment of its release. The following features are required from a fully scaleable optical network: lasers tunable into a specified wavelength range, a receiver tunable within the same or larger wavelength range as the tunable laser and the capability of the wavelength router to make dynamic cross-connects between different channels. It is obvious from this short review of the wavelength management and routing architecture of AON, that TBPOF is one of its key elements. From the optical standpoint, TBPOF must be able to provide the separation required by the grid: 100 GHz, 50 GHz or 25 GHz for any selected channel in the wavelength range, and also to provide a good rejection of all the other unwanted channels. The TBPOF must also be able to communicate with the optical network monitoring system, (ONMS). Some of the key communication issues concern the tuning wavelength value. The TBPOF should be able to notify the ONMS when it reaches a predetermined value, when wavelength lock and wavelength track are achieved and if there is enough signal amplitude on the selected wavelength to mention just few dialog issues. The communication between the TBPOF and NMS must be done for different applications of TBPOF, which include its use at the source side (tunable laser with external cavity), at the receiver side and also in the wavelength router.

### DESCRIPTION OF THE PRIOR ART

The prior art has several approaches to achieve a TBPOF, which are described below.

U.S. Pat. No. 5,739,945 (the '945 patent) presents an electrically tunable optical filter utilizing a deformable multi-layer mirror as presented with reference to FIG. 1. The '945 patent describes a tunable Fabry-Perot interferometer integrated into a semiconductor structure using a microelectromechanical system (MEMS) into a GaAs wafer, 101. The invention discloses a layered structures of n-GaAlAs, 102, n-AlAs, 103, and n-GaAlAs and air, 106. Because GaAlAs has a very high refractive index (3.5), and the air has a low refractive index 1.0, the multi-layered structure 106 has a very high reflectivity of about 99.9% over a 700 nm bandwidth with only three layers of n-AlAs and air. Moreover, due to the thickness of the multilayered structure it is easily moved by an electric field. The tunable Fabry-Perot interferometer of the '945 patent, having the input light beam 108 and the output beam 109, is built between the two high reflectivity structures: the bottom multilayer 106 and the cantilever 105, with the air gap 107 created with a sacrificial layer 104 made of AlAs that separates the two structures. The size of the gap 107 determines the tuning wavelength. By applying a voltage between the cantilever 105 and the multilayer 106, the size of the gap 107 changes, which tunes the Fabry-Perot interferometer wavelength range. However, from the technological standpoint, the implementation of very high reflectivity stacked layers presents several problems. From the optical standpoint, the tunable Fabry-Perot interferometer according to the '945 patent has some drawbacks, such as: the loss of the parallelism between the cantilever 105 and the multilayer 106 when the cantilever bends under the force of the electric field, drastically reducing the selectivity to about 0.33 nm, which is below the required value. In order to improve further the mechanical behavior of the movable mirror, the prior art presents also a trampoline structure that does not represent a drastic improvement in terms of optical alignment versus the cantilever embodiment. There are some other drawbacks typically associated with Fabry-Perot interferometers in general, and in particular with the Fabry-Perot interferometers built using MEMS technology. These include: high insertion losses because of the transmission through high reflectivity mirrors which are used as optical input and output ports and also as mirrors of the resonator, high sensitivity to temperature, high diffraction losses because of the roughness of the top and bottom layers of the multilayered structure due to their fabrication by semiconductor technology techniques, difficulties in achieving the parallelism of the reflectors at the manufacturing level, the dependence of the gap 107 on the control voltage 110 with uncontrollable tolerances, lack of position sensors to detect the value of the gap 107, which thus makes closed loop monitoring of the interferometer impossible.

U.S. Pat. No. 4,400,058 shows a basic configuration of low-order tunable Fabry-Perot filter, achieving the tunability in 3 μm to 40 μm wavelength range, by adjusting the spacing between mirrors. The patent does not give any detail related to the transmission characteristics, but affirms that there are multiple transmission peaks in its working range.

U.S. Pat. No. 5,283,845 shows an example of a Fabry-Perot interferometer used to filter out a specific wavelength into a spectral range, by changing the spacing between mirrors with a piezo-element. The incident angle into the Fabry-Perot filter is non-zero, to achieve an angular separation between the incoming beam and the two outgoing beams, transmitted and reflected. Wavelength selection from the incoming beam, containing a plurality of wavelengths, is obtained either in the transmitted beam, or in the reflected beam. The patent also mentions the cascading capabilities of the claimed tunable filter. It does not mention anything regarding the selective properties of the Fabry-Perot interferometer used, and its polarization dependence.

U.S. Pat. No. 4,861,136 is using a high-order Fabry-Perot interferometer having a fiber optic waveguide inside a short cavity of about 5 mm long. A piezo-ceramic is used as an actuator to change the distance between the mirrors. The description further states that the higher fine adjustability of the actuator increases selective properties, but increases also the insertion losses in the passband. The description also states that there are high losses due to diffraction. A key drawback is that as the losses decreases, the selectivity decreases as well.

U.S. Pat. No. 5,251,275 describes a tunable element. That element is a very low-order Fabry-Perot interferometer incorporated into an integrated structure, together with its input and output optical fibers. The patent however includes no information about the selective properties and about losses of the disclosed configuration.

U.S. Pat. Nos. 4,813,756; 5,287,214; 5,481,402; 5,506,920; 5,684,632; 5,781,332; 5,781,341 all describe in slightly different embodiments, the same approach of wavelength tuning. The approach is characterized by changing the incidence angle into a Fabry-Perot filter constructed either as parallel flat glass surface having reflective coatings on both sides, or built just as a multi-layer coating on a transparent substrate.

U.S. Pat. No. 4,553,816 describes a configuration of two cascaded Fabry-Perot interferometers to achieve a narrow passband filter tuned over a broad wavelength range. The two interferometers are both high-order, with multiple transmission peaks, unevenly spaced for each interferometer. The spacing between the mirrors of each cavity is filled with an electro-optic material. Only one main transmission peak over the entire spectral range can be obtained by properly adjusting the ratio between the mirror spacing of the two interferometers. A single control voltage is used to change the refractive index of the electro-optical material of each interferometer, thus achieving the optical tunability. Nowhere in the specification is the magnitude of the ratio between the spacing of the interferometers disclosed. Also there is no comment regarding the resultant transmission bandwidth, the free spectral range of the cascaded connection, and about the spurious peaks.

U.S. Pat. No. 4,896,948 (the '948 patent) also presents two cascaded Fabry-Perot interferometers to improve the wavelength selective properties of the cascade. Both Fabry-Perot interferometers have their gap filled with electro-optic material. The difference between the gaps of the interferometers drastically improves the rejection of unwanted transmission peaks, when it is properly selected. Tuning is achieved by applying the same control voltage on both interferometers. In contrast to the current invention, the invention disclosed in the '948 patent does not account for polarization-dependent behavior that is inherent to the electro-optic effect.

U.S. Pat. No. 5,039,201 also discloses using two cascaded Fabry-Perot interferometers with different lengths to improve the sensitivity of the resulting filter and to minimize the number of transmission peaks, within the free spectral range. The gap of the interferometers is filled with media having different refractive indices such as liquid and gas to shift the transmission peaks.

U.S. Pat. No. 5,621,828 describes an integrated tunable optical filter built using semiconductor waveguides, with two cascaded wavelength-selective sections, to achieve simultaneously a high spectral selectivity and a broad tuning range. One of the wavelength-selective sections is high order and has many narrow transmission peaks in the spectral range. This section is cascaded with a very low-order wavelength-selective section, having only one transmission peak in the spectral range. As a result of this cascaded connection, only one narrow transmission line is selected, the amplitude of spurious peaks in the resultant transfer function being strongly minimized.

U.S. Pat. Nos. 4,240,696 and 4,929,063 presented similar electrical methods to adjust the refractive index of each layer of a multi-layer selective interference filter. Consequently, the selective properties are controlled by electrical means. In principle this method can provide an attractive mean for adequate wavelength tuning for DWDM applications, but its implementation is subject to serious practical limitations.

U.S. Pat. No. 5,136,671 discloses an arrayed wavelength grating (AWG) approach for multiplexing and demultiplexing wavelengths, used in DWDM applications. In spite of its very good wavelength selection properties, AWG has each output assigned for one wavelength only. AWG must therefore be combined with an array of optical switches in order to direct many outputs of AWG to a single output port in order to implement a tunable filter. Moreover, AWG structures are very sensitive to temperature and to polarization.

U.S. Pat. No. 5,493,625 uses a combination of optical switches and AWG to implement a tunable optical dropping filter. The preferred embodiment of this patent is interesting, but it has very serious practical limitations, related to the insertion loss and to mechanical instabilities.

U.S. Pat. No. 5,542,010 introduces an improvement on the U.S. Pat. No. 5,493,625 mentioned above. The patent discloses cascading two filters using the combination of AWG and switches: a low-resolution filter, followed by a high resolution filter, to improve wavelength selectivity.

In U.S. Pat. No. 5,488,500 a tunable filter with AWG gratings and optical switches is presented. Optical switches introduce additional insertion losses and have slow response time, in the range of tens of millisecond.

U.S. Pat. No. 5,233,405 describes a double-pass monochromator with diffraction grating for wavelength selection, used in optical spectrum analyzers. For high wavelength resolution, it uses a very narrow slit to achieve the resolution required for DWDM applications. However this configuration also increases insertion losses well above the acceptable level for a filter required for optical communication purposes.

An AWG filter, tunable by thermo-optic methods, is presented in the paper of S. Toyoda et al., “Polarization-Independent Low-Cross-Talk Polymeric AWG-based Tunable Filter Operating Around 1.55 μm”, in “IEEE Photonics Technology Letters”, vol. 11, No. 9, pp. 1141-1143, September 1999. The approach disclosed in this paper has several drawbacks. Specifically, the thermal approach to achieving tunability is inherently slow, and also introduces thermal and mechanical stress into the fiber.

It is therefore an object of the present invention to provide a tunable band pass optical filter as an integrated system, having a multi-beam tunable interferometer described in the U.S. patent application Ser. No. 09/705,447 as a wavelength tunable element, and an electronic controller to monitor the operation of the filter and also to make the dialog between the tunable band pass optical filter and the optical network monitoring system.

It is also a further object of the present invention to achieve the tunability of the multi-beam tunable interferometer by effecting the movement of the mirrors by exclusively using piezo-ceramic actuators and flexure elements. This system avoids any positioning error due to backlash, and achieves a highly accurate positioning of the reflective layers.

It is yet a further object of the present invention to provide a tunable band pass optical filter able to be used in all wavelength bands assigned for CWDM, WDM and DWDM, including in optical service channels (OSC).

It is yet a further object of the present invention to make the tunable band pass optical filter able to be optically connected in cascade with another filter of the same type or with any other fiber optic component of an optical network.

It is yet a further the object of the present invention to make a tunable band pass optical filter with a custom transfer characteristic. This feature is achieved by chain cascading some tunable band pass optical filters built according to the present invention.

It is yet a further the object of the present invention to make the tunable band pass optical filter insensitive to the polarization of the incident beam.

It is yet a further object of the present invention to make the tunable band pass optical filter with wavelength search, lock and track functions able to find the required wavelength in the input optical signal, to lock the filter at the specified wavelength and eventually to track the filter to that wavelength when its value drifts for some reasons.

It is yet a further object of the present invention to make the tunable band pass optical filter with a wavelength amplitude measuring function which can determine if the amplitude of the required tuning wavelength is outside a predetermined limit (optical channel monitoring).

It is yet a further object of the present invention to make the tunable band pass optical filter that can be controlled by external commands such as: wavelength search, wavelength lock, wavelength track, amplitude check and other specific commands.

It is yet a further object of the present invention to make the tunable band pass optical filter able to send to an optical network monitoring system, information on optical signal quality such as low optical signal.

The tunable band pass optical filter of the present invention provides a number of advantages in comparison with the prior art.

Tunable band pass optical filter according to the present invention can work with any polarization state of the incident beam, which remains unchanged in the output beam.

The bandwidth and the insertion loss of the disclosed TBPOF and of its cascaded combinations can be customized according to the application. The bandwidth of TBPOF is constant in the whole tuning range, and the insertion loss of TBPI is much lower than the insertion loss of a Fabry-Perot filter with the equivalent finesse.

TBPOF has no eigenmodes and by consequence it is continuously tunable either by a monotonic function, or by a very large number of non-monotonic steps covering a quasi-continuous wavelength range, the tunability being achieved by adjusting the gap between the reflective layers.

TBPOF can work in any wavelength range used in optical communications between 1260 nm and 1675 nm, by adjusting the gap between the reflective layers into a certain spacing range and eventually by optimizing the reflective layers for required wavelength range.

TBPOF according to the present invention has position sensors as feedback elements to control the gap between the reflective layers.

TBPOF according to the present invention can also have beam samplers built with fiber optic tap couplers that take a fraction of the output optical signal and send it to a photo detector for intensity monitoring of the optical signals.

### SUMMARY OF THE INVENTION

According to the present invention, these and other objectives and advantages are achieved using the tunable band pass optical filter system with a tunable band-pass interferometer. A tunable band pass optical filter with tunable band-pass interferometer according to the present invention comprises a tunable band pass optical filter comprising a frame, at least one translation plate, at least one flexure element for mounting said at least one translation plate to said frame, a first mirror mounted to said at least one translation plate, a second mirror mounted to said frame in optical communication with said first mirror, having a distance between said first and said second mirror, at least one compensation screw operatively connected to said frame and said at least one translation plate; and at least one piezo-ceramic actuator operatively connected to said frame and said at least one translation plate.

According to the features of the present invention, the tuning of the filter on a required wavelength is accomplished using piezo-ceramic actuators and flexures to adjust the gap between the reflective layers of tunable band-pass interferometers, in a closed loop system using a feedback signal to measure and adjust the gap between the reflective layers and also an intensity feedback signal generated by a low-frequency photo detection circuit linked with a fiber optic tap coupler.

According to yet another feature of the invention, the wavelength range of the main transmission peak of the filter can be adjusted by adjusting the gap between the reflective layers at certain ranges such as: μm, tenths of μm and mm.

According to yet another feature of the present invention, the bandwidth of the filter can be adjusted by changing the incidence angle into interferometer.

According to yet another feature of the present invention, the main transmission peak can be shifted into a broad wavelength range by slight adjustments of the gap between the reflective layers within a particular predetermined range. According to the features of the present invention both the amplitude and the band pass of the main peak remaining constant in the tuning range.

According to yet another feature, more than one tunable band pass optical filter according to the present invention can be cascaded in order to obtain either a narrower main peak and smaller spurious peaks or a custom-defined transfer characteristic.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1 is a schematic drawing of a tunable band pass optical filter according to the prior art.

FIG. 2 is a cross section with a plane containing the optical beam, through a preferred embodiment of a tunable band pass optical filter with tunable band pass interferometer.

FIG. 3a is a schematic of the offset sub-assembly of the tunable band pass interferometer of the tunable band pass optical filter.

FIG. 3b is a schematic of the tuning sub-assembly of the tunable band pass interferometer of the tunable band pass optical filter.

FIG. 4a is a view of the tuning translation plate with its flexure system, seen from the direction of the output beams of the interferometer (direction A in FIG. 2).

FIG. 4b is a cross section with a plane going through direction CC (FIG. 4a), through the tuning translation plate with its flexure system and the tuning piezo-ceramic actuator.

FIG. 4c is a schematic cross section with a plane going through direction DD (FIG. 4a), through the tuning translation plate with its flexure system and the tuning piezo-ceramic actuator.

FIG. 5a is a zoom of the encircled region of FIG. 4b, with a very small preloading force TF1.

FIG. 5b is a zoom of the encircled region of FIG. 4b, with a large preloading force TF2.

FIG. 6a is a detail of the piezo-ceramic actuator that drives the translation plate.

FIG. 6b is a viewgraph of the translation characteristic of the piezo-ceramic actuator.

FIG. 7a is a cross-section through the axis of the fiber optic collimator holder.

FIG. 7b is a view of the fiber collimator holder, seen from the lens side.

FIGS. 8a, 8b and 8c are viewgraphs of the transmission versus wavelength characteristic for a low order TBPI, having the following main parameters: gap D between the reflective layers in the range 12.20 μm to 12.81 μm depending on tuning wavelength, the incidence angle θ=1.0°, total reflection layer with reflectivity r1=0.985 and the absorption coefficient a1=0.006; the partial reflection layer with reflectivity r2=0.930 and the absorption coefficient a2=0.006; the number of interfering beams p=40.

FIGS. 9a, 9b and 9c are viewgraphs of the transmission versus wavelength characteristic for a high order TBPI, having the following main parameters: spacing between the reflective layers in the range 11.70128 mm to 12.75000 mm depending on tuning wavelength, the incidence angle θ=1.0°, total reflection layer with reflectivity r1=0.985 and the absorption coefficient a1=0.006; the partial reflection layer with reflectivity r2=0.930 and the absorption coefficient a2=0.006; the number of interfering beams p=40.

FIGS. 10a, 10b and 10c are viewgraphs of the transmission characteristics versus wavelength of two stage TBPOF made of two single-stage vernier-cascaded high-order TBPI, both TBPI having the total reflection layer with reflectivity r1=0.985 and the absorption coefficient a1=0.006, the partial reflection layer with reflectivity r2=0.930 and the absorption coefficient a2=0.006, the number of interfering beams p=40, the incidence angle θ=1.0°, the gap D between the reflective layers being 11.875 mm and respectively 11.937 mm in FIG. 10a, 12.125 mm and respectively 12.165 mm in FIG. 10b, and 12.125 mm and respectively 12.165 mm in FIG. 10c.

FIGS. 11a, 11b and 11c are viewgraphs of the transmission versus wavelength characteristic of three-stage TBPOF made of two vernier-cascaded high-order TBPI further cascaded with a single stage low-order TBPI, all three TBPI having the total reflection layer with reflectivity r1=0.985 and the absorption coefficient a1=0.006, the partial reflection layer with reflectivity r2=0.930 and the absorption coefficient a2=0.006, the number of interfering beams p=40, the incidence angle θ=1.0°, the spacing between the reflective layers being 11.877 mm, 11.939 mm and respectively 12.120 μm in FIG. 11a; 12.123 mm, 12.168 mm and respectively 12.350 μm in FIG. 11b, and 12.625 mm, 12.665 mm and respectively 12.72 μm in FIG. 11c.

FIG. 12a is a view from direction A (FIG. 2) of the preferred embodiment of one-stage TBPI, showing the offset reflective sub-assembly with the offset translation plate, the tuning reflective subassembly with the tuning translation plate and some of their associated parts.

FIG. 12b is the offset sub-assembly of TBPI with the input fiber collimator holder in the background.

FIG. 12c is the tuning sub-assembly of TBPI.

FIG. 13a shows the one-stage TBPI, seen from direction B (FIG. 2).

FIG. 13b is the symbolic representation of one-stage TBPI.

FIG. 14a is a view from the side of input fiber optic collimators, of two-stage TBPOF made of two cascaded TBPI.

FIG. 14b is a view from the side of output fiber collimators, of the two-stage TBPOF made of two single-stage cascaded TBPI. Common to FIGS. 14a and 14b are the fiber optic tap couplers and the pigtail photodiodes that generate intensity feedback signal.

FIG. 15 is the symbolic representation of the two-stage TBPOF made of two single-stage vernier-cascaded TBPI, including the fiber optic tap couplers and the pigtail photodiodes that generate intensity feedback signal.

FIG. 16 is the symbolic representation of the three-stage TBPOF made of two single-stage vernier-cascaded TBPI, further cascaded with one-stage TBPI, including their beam intensity feedback elements.

FIG. 17 is the symbolic representation of the three-stage TBPOF, together with the controller of the tunable band pass optical filter and with the optical network monitoring system.

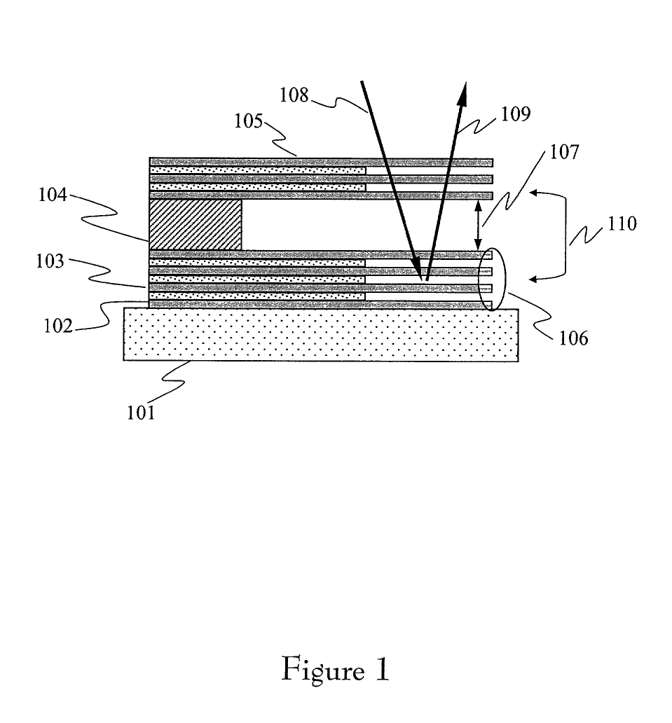

### DETAILED DESCRIPTION OF THE INVENTION

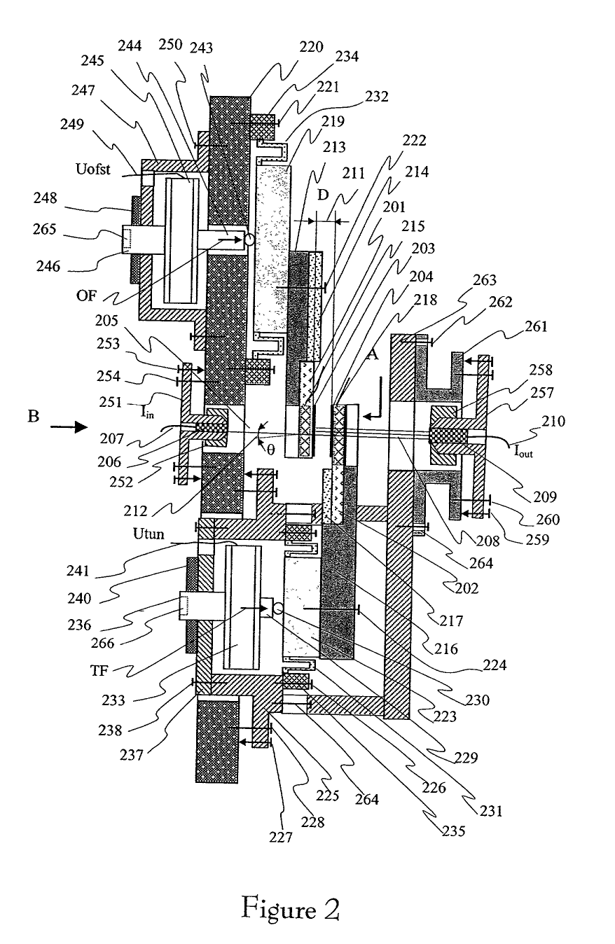

A preferred embodiment of the tunable band pass optical filter with two-sided version of the tunable band pass interferometer (TBPI) as described in the U.S. patent application Ser. No. 09/705,447, is shown schematically in FIG. 2. The description given below about the operation of the tunable band pass optical filter based on the preferred embodiment is also valid for any other embodiments of the tunable band pass optical filter using a tunable band pass interferometer and does not limit other embodiments using the same TBPI. The practical implementation of this configuration may differ from one application to another, but the basic ideas expressed in this patent remain the same.

According to the preferred embodiment of this invention as shown schematically in FIG. 2, the transparent plates 201 and 202 contain the reflective layers of TBPI. The plate 201 has the layer 203 with very high reflectivity and very low absorption. Layer 203 is also known as the total reflective layer and is parallel and facing the partial reflective layer 204. Layer 204 is coated on plate 202 and has lower reflectivity than layer 203, furthermore it has very low losses. An optical fiber 207 is the input optical port of the TBPI for the multitude of wavelengths associated with the DWDM technology.

In operation, a transmitting fiber optic collimator 206 accepts the input optical signal and generates a narrow collimated beam 205 from the light beam carried by the optical fiber 207. According to the operating principle of TBPI described in the U.S. patent application Ser. No. 09/705,447, the light beam 205 input into the TBPI is incident first on the partial reflective layer 204 at an angle 212 having θ≈1°, it then bounces many times between the total reflective layer 203 and the partial reflective layer 204, generating the multiple parallel beams 208 at the output of the TBPI.

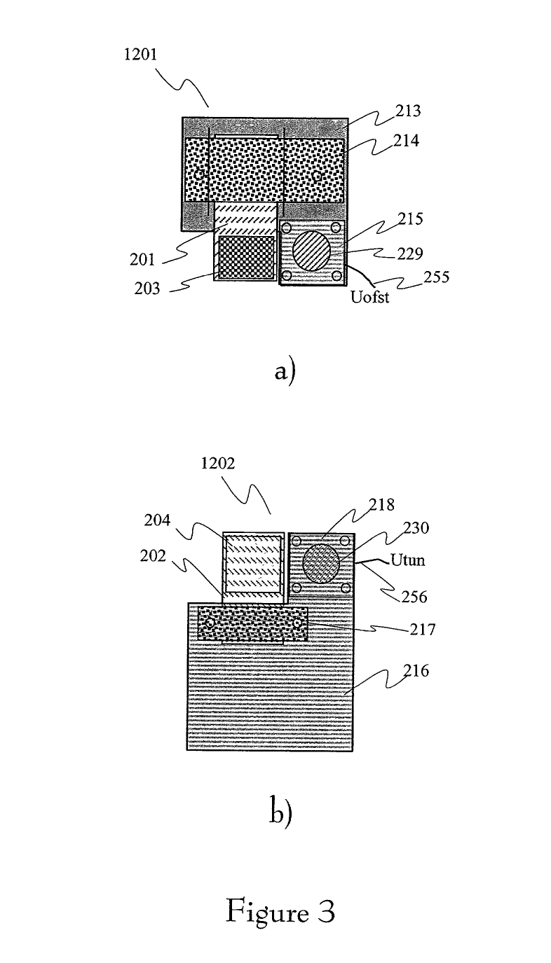

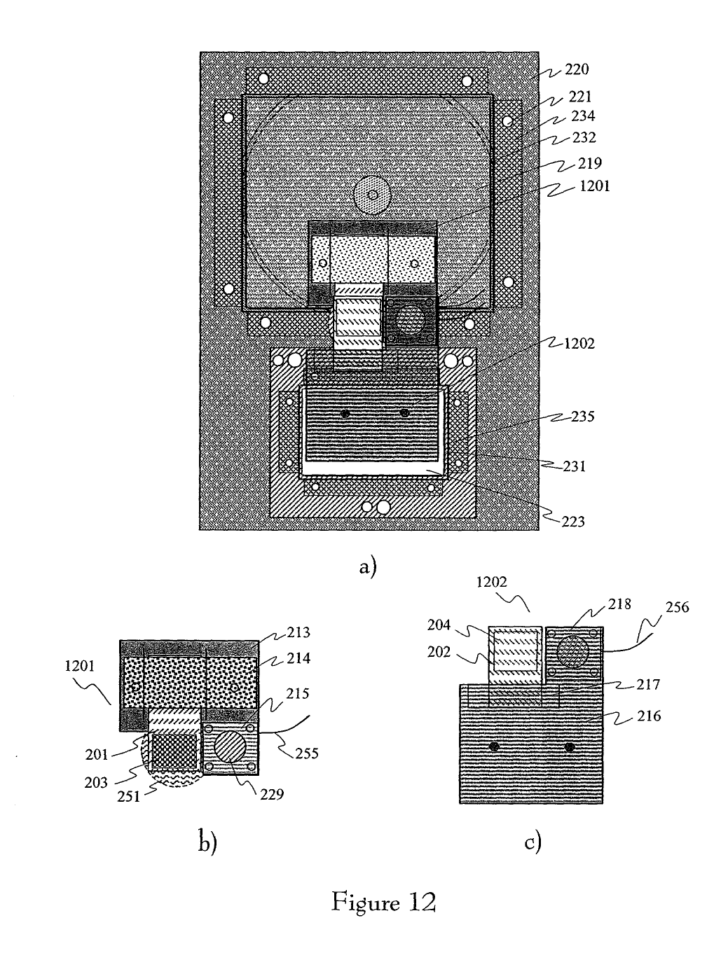

A receiving fiber optic collimator 209 collects all the beams 208 and focuses them into an output fiber 210, which constitutes the output optical port of the TBPI. Transparent plate 201 is locked into a plate holder 213 by a plate cover 214 and transparent plate 202 is locked into a plate holder 216, by a cover 217. The transparent plate 202, holder 216, cover 217 and the position sensor 218 comprise the tuning assembly 1202, which is depicted in FIG. 3b and additionally in FIG. 12c. In FIG. 12c. the assembly is viewed from direction A (FIG. 2).

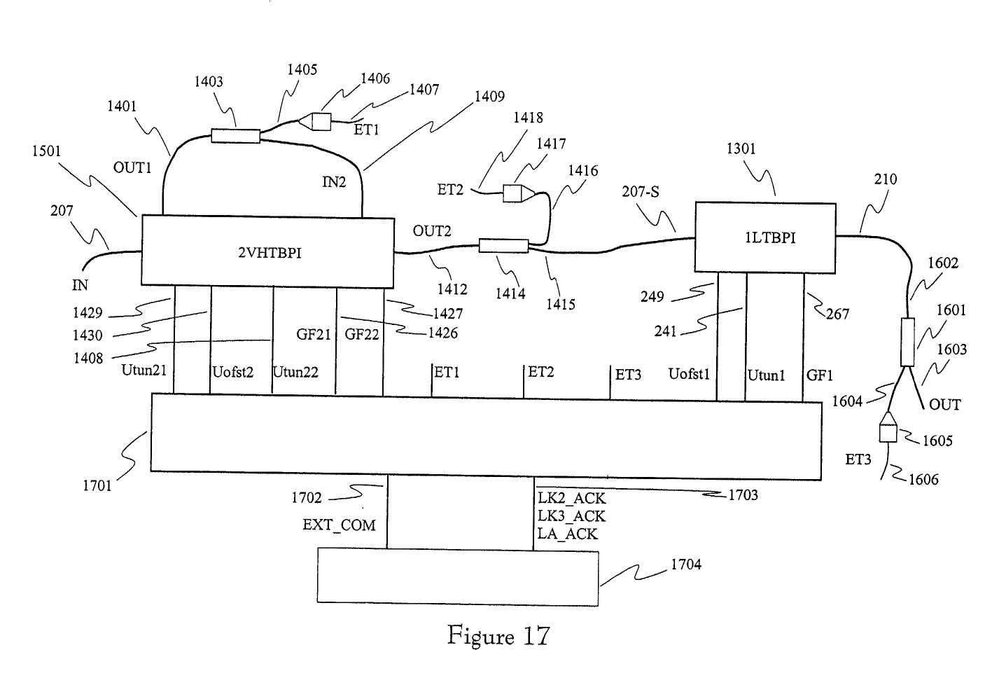

The assembly including the transparent plate 201, plate holder 213, plate cover 214 and position sensor 215 is known as the offset assembly 1201, as shown in FIG. 3a and FIG. 12b. In FIG. 12b. the assembly is viewed from direction A (FIG. 2). The position sensor 215 is mounted on the plate holder 213 very close to the reflective layer 203, position sensor 218 is mounted on the holder 216 very close to the reflective layer 204. Positions sensors 215 and 218 must have their sensitive areas 229 (FIG. 3a) and 230 (FIG. 3b) parallel and facing each other, in order to generate an optimum signal proportional to the gap D between the reflective layers 203 and 204. The controller 1701 (FIG. 17) uses this signal to adjust the gap D in order to tune the TBPI to a required wavelength.

The tunability of TBPI according to the preferred embodiment of the present invention will be more completely explained below, in this description. TBPI as it is presented in the U.S. patent application Ser. No. 09/705,447 and used in the present embodiment of the invention must have the gap D in μm's range for a low-order TBPI and in mm's range for high-order TBPI. By adjusting the gap D, while also keeping layers 203 and 204 parallel, and position sensors 215 and 218 parallel, wavelength selection can be acheived. In the preferred embodiment of this invention, this requirement to keep the layers and position s sensors parallel to achieve tunability while changing gap D is enabled by using flexure elements driven by piezo-ceramic actuators, as it will be explained herein. T

The offset assembly 1201 is rigidly mounted with screws 222 to an offset translation plate 219 containing the flexure elements 232 and the frame 234. The frame 234 is rigidly mounted onto a base plate 220 also using screws 221. The position of the total reflective layer 203 of the TBPI mounted as described herein and above will be a reference for the position of the partial reflective layer 204 of the TBPI, which must be parallel with 203 and spaced at the distance D from it. The base plate 220 will also be used to mount some other parts of the filter, as it will be explained later. The offset translation plate 219 has flexure elements 232 and a frame 221.

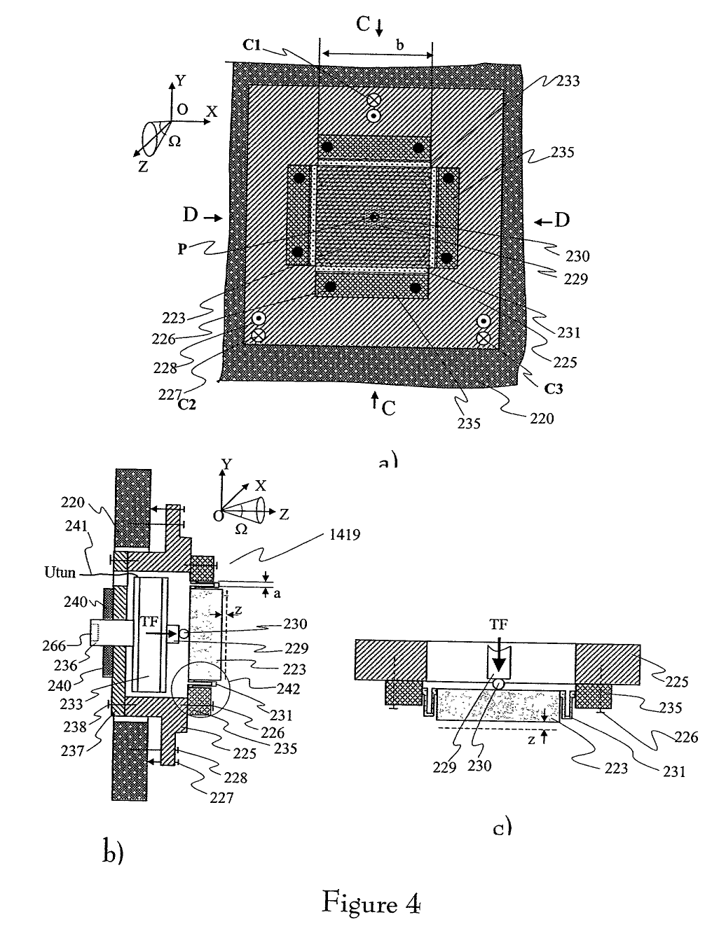

The tuning assembly 1202 is rigidly mounted to a tuning translation plate 223 with screws 224. The translation plate 223 also contains the flexure elements 231 and the frame 235. The frame 235 is rigidly mounted on the piezo housing 225 using screws 226. The piezo housing 225 is mounted on the base plate 220 using three pairs of push screws 227 and pull screws 228. The use of push-pull screws to mount the piezo-housing 225 on the frame 220 and to mount other elements of the present embodiment of this invention will be further explained below in this description. In the preferred embodiment of this invention, the offset translation plate 219 is similar in nature with the tuning translation plate 223. The key difference between the translation plates 219 and 223 is their dimensions, and because of this similarity, their construction and operation will be explained in relation with FIGS. 4a, 4b and 4c, where there is shown schematically the tuning translation plate 223 containing also the flexure elements 231 and the frame 235 that is rigidly mounted on the piezo housing 225 with the screws 226. With the frame 235 rigidly mounted on the piezo-housing 225, the tuning translation plate 223 presses against the ball 230, which in turn presses against the piezo pushing rod 229. The pushing rod 229 is mounted on one side of the piezo-ceramic actuator 233. On the other side of the piezo-ceramic actuator 233 and rigidly mounted to it, is the compensation screw 236 mounted in the piezo-cover 237 that is rigidly mounted on the piezo-housing 225 with some screws 238.

The nut 240 locks the compensation screw 236 into a predetermined position, in which a reactive preloading force TF transmitted through the compensation screw 236, the piezo-ceramic actuator 233, the piezo pushing rod 229 and the ball 230 pushes on the tuning translation plate 223 and induces a small displacement z versus its position when there is no pre loading force (TF=0) applied to it (FIG. 4b). The use of ball 230 makes the link between pushing rod 229 and translation plate 223 flexible, thus no forces non-axial with Oz can be transmitted from the piezo-actuator to the translation plate 223.

It is desirable in the preferred embodiment of the present invention that the displacement z of the translation plate 223 should occur predominantly on the Oz axis that is normal to the surface of the translation plate. Therefore, even when TF is changing its value, there is maintained a minimal tolerance angle Ω (about 0.25°) between the translation plate and the Oz axis (FIG. 4b), with infinitely high resolution and without any backlash. In the preferred embodiment of this invention used in the description herein, these conditions are met by using flexure elements 231 between the translation plate 223 and the frame 235. In the preferred embodiment, the elements 223, 231 and 235 are regions of a single part. However, in other embodiments, the elements 223, 231 and 235 can be separate parts assembled together, or 223 and 231 in one part assembled with 235, or 223 being a separate part assembled with 235 and 231 as a single part. Various other combinations are possible and one skilled in the art could readily modify elements 223, 231 and 235 to best accommodate the needs of the particular application.

The compensation screw 236 must have such a position adjusted during the alignment procedure, that a pre-loading force TF must always push the translation plate 223 against the ball 230 and toward the pushing rod 229, in order to avoid any backlash when TF reduces its value during the operation of the filter, to move the translation plate 223 toward the base plate 220.

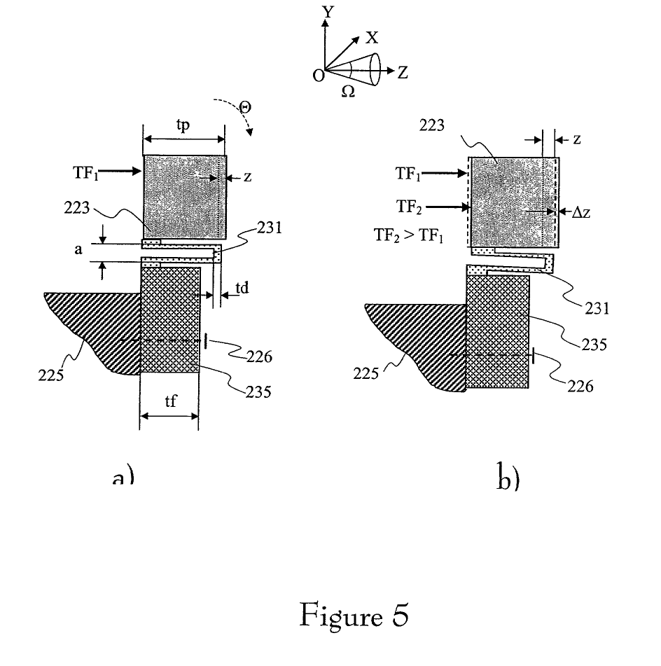

The displacement of the translation plate 223 parallel with Oz under the action of the force TF is controlled by the appropriate shape and orientation of the flexure elements 231. The preferred embodiment of the flexure elements 231 to control displacement of the translation plate 223 in parallel alignment, under the action of the force TF is shown in FIGS. 4a, 4b and 4c, however it would be obvious to one skilled in the art to modify the flexure elements to suit the needs of an alternate embodiment. In the preferred embodiment of this invention, the translation plate 223 has a square shape with side size b having flexure elements on each side. This geometry of flexure elements with central symmetry cancels the forces non-collinear with Oz appearing in flexures under the action of the force TF, allowing the translation plate to move only collinear with Oz axis. In FIG. 4a, each side of the translation plate 223 contains one flexure element 231; the sides of the translation plate 223 being respectively parallel with coordinate axes Ox and Oy. A detailed view of a cross-section through a flexure element 231 is shown in FIGS. 5a and 5b, which is an expanded view of the encircled area 242 (FIG. 4b). In the preferred embodiment of the present invention, the flexure element has a U shape cross-section, with the bottom part of the U oriented toward the face of the translation plate 223 that has the tuning assembly attached. One of the sides of U being part of the translation plate 223 and the other side of the U being part of the frame 235. As an example, the total width of the U-shape profile is a about 1 mm, with ratio b/a in the range of 20 to 40. The translation plate 223 and the frame 235 are both more rigid than the flexure 231 along the direction Oy (FIG. 5a), where tp is the thickness of the plate 223, tf is the thickness of the frame 235 and td is the thickness of the flexure 231. In the preferred embodiment of the invention, tp and tf are in mm's range; td is in tenth of mm's range, the translation plate 223 and the frame 235 are made of a rigid material and the flexures 231 are made of an elastic material. All flexure elements used in the preferred embodiments of the present invention must work only in the linear range of their elastic deformation, within the entire operating range. The operation of all flexure elements of the preferred embodiment of this invention will be described with reference to FIGS. 5a and 5b, where the flexure 231 has its “b” side parallel with Ox direction. The preloading force TF1 applied normal to the translation plate 231 will be applied also to one side of the flexure 231, the other side of the flexure 231 remaining locked in contact with the frame 235, which is rigidly mounted on the piezo housing 225. The translation plate 223 and the frame 235 are more rigid than the flexure 231 and because of the high ratio b/a of the flexure 231, the bending moment along the direction Oy will be much smaller than the bending moment along the direction Ox. The flexure 231 will bend toward the frame 235 when the force TF1 will be applied to the translation plate 223. As a result of the bending the flexure 231, the translation plate 223 moves linearly with z along the Oz axis and an eventually rotates with an angle O (FIG. 5a). Because the point P (FIG. 4a) where the ball 230 pushes against the translation plate 223 is located in the symmetrical center of the translation plate 223 with respect to the positions of all the flexures 231 and because each side of 223 has identical flexures 231, the possible rotation with angle ΘΩ of the translation plate 223 is cancelled out. The plate can thus only move in linear translation. Some other preferred embodiments of the shape of the translation plate 223 can be: rectangular, hexagonal, circular, or any other shape with a symmetry center with respect to the position of flexure elements.

The pushing force TF also known as the tuning force is defined as the algebraic sum of the preloading force TF0 necessary to always keep the translation plate 223, the ball 230 and the piezo pushing rod 229 in contact, and a tuning force TFz generated by the piezo actuator 233, when a tuning voltage Utun is applied to its electrical terminal 241, to change the dimension of the piezo actuator 233 along the axis Oz (TF=TF0+TFz). For the purposes of this explanation, it will be considered that TFz is added to TF0 when Utun is positive and is subtracted from TF0 when Utun is negative. FIG. 5a shows the case when Utun=0 and the displacement z of the translation plate 223 appears only under the action of the preloading force: TF1=TF0. FIG. 5b shows the case when Utun>0, TFz>0 and TF2>TF1, which produces the additional displacement Δz needed to adjust the gap size D (FIG. 2) at the proper value and to tune TBPI to a specific wavelength. A negative Utun will produce a negative Δz, i.e. the offset z decreases. Some embodiments of this invention may use only positive voltages Utun and smaller preloading force TF0 to achieve the same end result.

The ball 230 decouples the linear displacement of the translation plate 223 from the non-axial component of the pushing force TF generated by any misalignment between the pushing rod 229 and the normal to the surface of 223 on which the tuning assembly 1202 is rigidly mounted (FIG. 3b). The misalignment can occur or be related to mechanical tolerances of the parts and to non-axial expansion of the piezo actuator 233 under the action of the control voltage Utun.

The parallelism and the required distance between the reflective layers 203 and 204 to tune the TBPI to a certain wavelength in accordance with the teachings of the U.S. patent application Ser. No. 09/705,447, is realized in the preferred embodiment of this invention by mounting the piezo housing 225 to the base plate 220 using three pairs of push screws 227 and pull screws 228. The push screws 227 are affixed to three contact points C1, C2 and C3 between the piezo housing 225 and the base plate 220, achieving the maximum of mechanical stability (FIG. 4a) and allow enough freedom to align reflective layer 204 parallel with the reflective layer 203. The pull screws 228 always maintain the contact between the push screws 227 and the base plate 220 and lock the position of the piezo housing 225 with respect to the base plate 220. The system of three push-pull screws adjusts and keeps the parallelism of the reflective layers 203 and 204 of TBPI within Ω˜0.25° accuracy. The screw system also permits a coarse adjustment of the gap D between the two reflective surfaces close to the value required to achieve the wavelength tunability function of the TBPI, which is accomplished by the precise motion of the translation plate 223 with the piezo actuator 233. The compensation screw 236 may provide additional adjustment of the gap D, to bring the span of possible variations of D within the displacement range of the piezo actuator 233. The wavelength tuning mechanism will be explained later during the description of the present invention.

As described in U.S. patent application Ser. No. 09/705,447 and as it will be presented herein below, some filtering properties require gap D between the reflective layers 203 and 204 in tens of μm range. It is very difficult to simultaneously achieve the required gap D and the parallelism of the reflective layers by simply adjusting the push-pull screws 227 and 228. According to the preferred embodiment of this invention, achieving a gap D in μm range between the reflective layers 203 and 204 while maintaining a parallel alignment of these layers is achieved by considering first as a reference, the position of the total reflective layer 203 when the offset assembly 1201 is fixed on the offset plate 219 rigidly mounted on the base plate 220. Then, the tuning assembly 1202 is adjusted to make the reflective layer 204 parallel with the total reflective layer 203 using the three pairs of push-pull screws 227 and 228. The push-pull screws are spaced at a reasonable distance D in the range of tenths of mm to not damage the reflective layers 203 and 204 during the alignment process. Pushing the offset plate 219 with the compensation screw 246, locked in a particular position with the nut 248 when D has the desired gap, can further decrease of D.

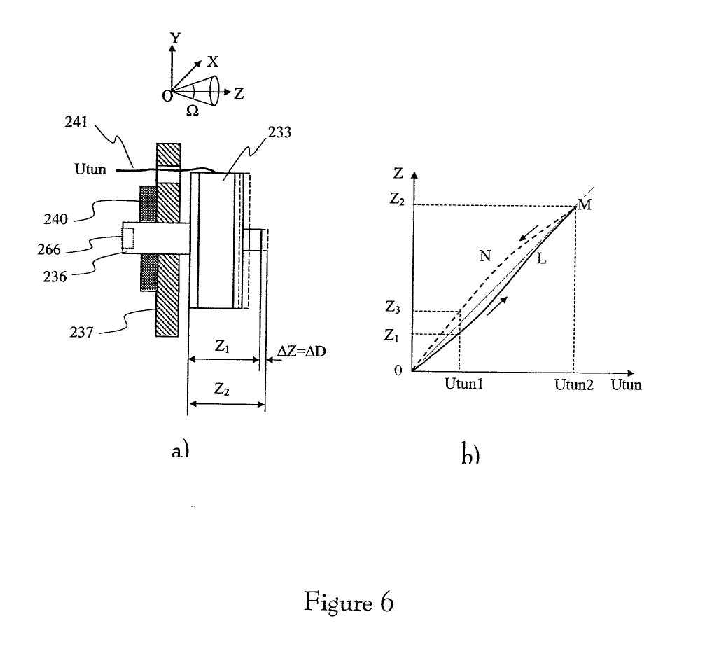

The translation plate 219 is mounted together with the flexure elements 232 and with the frame 221 in the same manner as the translation plate 223, the flexure elements 231 and the frame 235 are mounted together to realize [effect] the translation function of 223 explained herein above. The frame 234 is rigidly mounted on the base plate 220 with the fixing screws 221. A hole in the base plate 220 allows the piezo-ceramic actuator 245 to push the translation plate 219 using the pushing road 244 and the ball 243, with an offset force OF. The piezo actuator 245 has the compensation screw 246 mounted into the piezo housing 247 that is rigidly mounted on the base plate 220 with the fixing screws 250. The nut 248 locks the compensation screw 246 after coarse adjustment of the translation plate 219 to bring it in the position where the gap D between the reflective layers 203 and 204 can be further controlled only by the piezo actuator 245, under the action of the offset voltage Uofst. The offset force OF is similar in nature with the tuning force TF, [and it] having two components. One component is the preloading force OF0 generated by the offset screw 246 that pushes the translation plate 219 through piezo actuator 245, the rod 244 and the ball 243, when there is no offset voltage Uofst (Uofst=0) applied to its electrical cable 249. The second component is the dynamic positioning force OF_{d} generated when Uofst≠0, which is algebraically added to OF0 to give the resulting offset force OF=OF0+Of_{d}. The total offset force OF adjusts the gap D between the reflective layers 203 and 204 to the required value for optical tuning to a given spectral range, i.e. 1310 nm, 1550 nm. Further selection of a specific wavelength within each range is brought about by finely adjusting the gap D with the tuning force TF, generated by the piezo-actuator 233 driven by the tuning voltage Utun. The expansion of a piezo actuator versus an external control voltage such as Utun is very well known by those skilled in the art. The explanations given below in connection with FIG. 6a and FIG. 6b will be done for better understanding of the operation of the preferred embodiment of TBPOF according to the present invention. For a certain value of the drive voltage Utun1, the length Z₁ of the piezo-ceramic actuator 233 increases to Z₂ when the drive voltage increases to to Utun2. The dependence Z(Utun) is represented by the branch OLM (FIG. 6b) that shows a nonlinear function. The length variation ΔZ of the piezo actuator is always equal to the displacement ΔD of the moving plate 223 (ΔZ=ΔD). When the drive voltage decreases from Utun2 to Utun1, the dependence Z(Utun) is represented by the non-linear branch MNO located above the branch OLM, and the length of the piezo actuator 233 is Z3 (Z3>Z1), due to the hysterezis of the piezo-ceramic. Non-linearity and hysterezis of piezo actuator 233 may substantially affect the accuracy of monitoring the gap D between the reflective layers 203 and 204, the preferred embodiment of this invention uses the position sensors 215 and 218 as a position feedback element for a controller to achieve the required accuracy of monitoring D in 0.01 μm range, as it will be explained later during the description of the present invention. The above remarks related to the piezo-ceramic actuator 233 are also valid for any similar device.

The combination of offset piezo-ceramic actuator 245 and of tuning piezo-ceramic actuator 233 used in the preferred embodiment of this invention offers multiple possibilities for precise adjustments such as: drift compensation of D due to environmental parameters such as temperature and mechanical stress, adjusting the gap D at some specific values in order to select a specific wavelength range, to make a wavelength search, and tracking and locking, as it will be explained below.

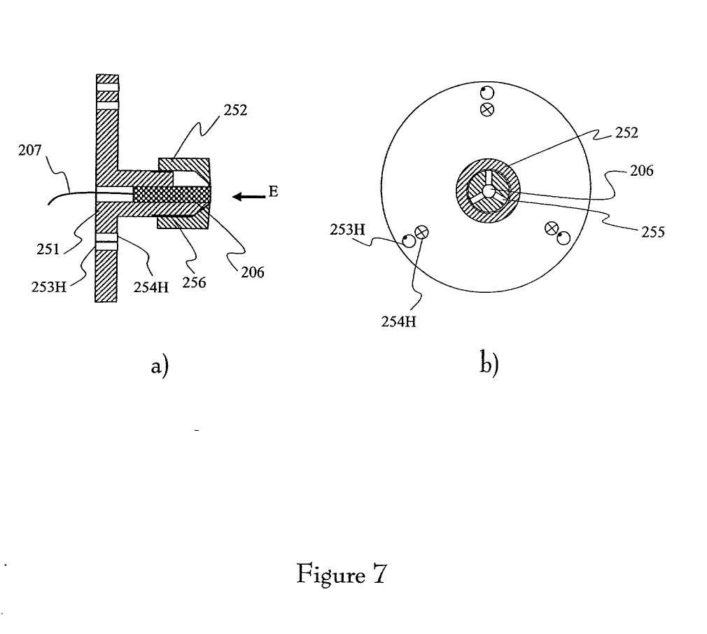

The light beam containing a multitude of wavelengths enters through the input optical fiber 207, which is the input optical port of TBPI and is collimated by a fiber optic transmitting collimator 206 into a narrow (about 1 mm diameter) collimated beam 205. In the preferred embodiment of the invention, the fiber optic transmitting collimator 206 is held into the input collimator holder 251, shown in detail in FIGS. 7a and 7b.

The collimator holder 251 has a body comprising a flange-type shape and a hollow cylinder in the same piece, the cylinder having some cutouts 255 at the end. The end of the cylinder has also a conical shape and a tread 256. The transmitting collimator 206 is held inside the cylinder and makes physical contact with the part of the cylinder having cutouts 255. The part of the cylinder in contact with the transmitting collimator thus functions as a flexure. A nut 252, having an inner conical shape that matches the outside conical shape of the cylindrical part 251, locks the transmitting collimator 206 in place when it is fastened. In the preferred embodiment the transmitting collimator 206 is always locked concentrically with the inner side of the cylindrical part of 251, thus minimizing potential misalignments due to eventual changes in the temperature of the holder 251 or to vibrations. The holder 251 has also threaded holes 253H for receiving the push screws 253 and unthreaded holes 254H for receiving the pull screws 254, the holes 253H and 254H being located at 120° as shown in FIG. 6b. The push-pull screws have a circular symmetry with respect to the optical axis of the transmitting collimator 206. The collimator holder 251 is mounted on the base plate 220 using three pairs of push screws 253 and pull screws 254, in the same manner as is mounted the piezo housing 225 on the base plate 220. The mounting using push-pull screw system provides for the adjustment of the incident angle θ of the input beam 205 at the entrance of the TBPI at a predetermined value as required for operation. In addition, it provides for good mechanical stability of the incident beam 205 at the entrance of TBPI.

The output beams 208 from TBPI are collected by the fiber optic receiving collimator 209, which focuses into the output optical fiber 210 the beam generated by multiple interferences between the output beams 208, as described in the U.S. patent application Ser. No. 09/705,447. The output optical fiber 210 is the optical output port of TBPI.

The output collimator holder 257 holds the receiving fiber optic collimator 209 in the same way as the input collimator holder 251 holds the transmitting collimator 206. The nut 258 locks the receiving collimator 209 into the holder 257. Three pairs of push screws 259, and pull screws 260 mount the collimator holder 257 on the output collimator housing 261, in a similar manner as the input collimator holder 251 is mounted on the base plate 220. The output collimator housing 261 is rigidly mounted on the frame 263 with the locking screws 262. The frame 263 is rigidly mounted on the piezo housing 225, containing the tuning piezo-ceramic actuator 233.

As it can be seen from the above description, the receiving collimator 209 is rigidly mounted on the piezo housing 225, which is also the reference mounting for the frame 235 of the translation plate 223 used to tune TBPI. The mounting solution described above for the preferred embodiment of this invention rejects at common mode all external influences, i.e. all movements made by the mirrors and the receiving collimator that are made simultaneously by the receiving collimator 209 with respect to the moving reflective layer 204 of TBPI. Aligning the receiving collimator 209 with the cross section of the output beams 208 is accomplished by moving the output collimator housing 261 into a plane perpendicular to the beam 208. Displacement is provided by sizing the mounting holes 264 inner diameter larger than the screws 262 outer diameter. The output collimator housing can then be locked in place when the desired position is achieved using the screws 262. The mounting of the output collimator holder 257 to the output collimator housing 261 using three pairs of push-pull screws 259 and 260 gives freedom of alignment of the optical axis of the receiving fiber collimator 209 with the direction of the output beams 208, provides a stable locking position and also facilitates common mode rejection resulting from possible misalignments due to temperature changes and vibration. Thus, the mechanical stability of the system is improved.

A view of TBPOF containing only one TBPI, further called single-stage TBPOF, seen from direction A (FIG. 2), is shown in FIG. 12a.

Before going further to describe alternate embodiments of TBPOF based on the preferred embodiment described herein and above, some of the advantageous transfer characteristics of TBPOF will be described.

In all the preferred embodiments of this invention, the transmission function T(λ) of a TBPI or of a TBPOF is the ratio between the beam intensity Iout at the output port 210 and the intensity Iin at the input port 207 (FIG. 2), which depends on wavelength as it is described in the U.S. patent application Ser. No. 09/705,447:

$$T ( λ ) = \frac{Iout}{Iin}$$

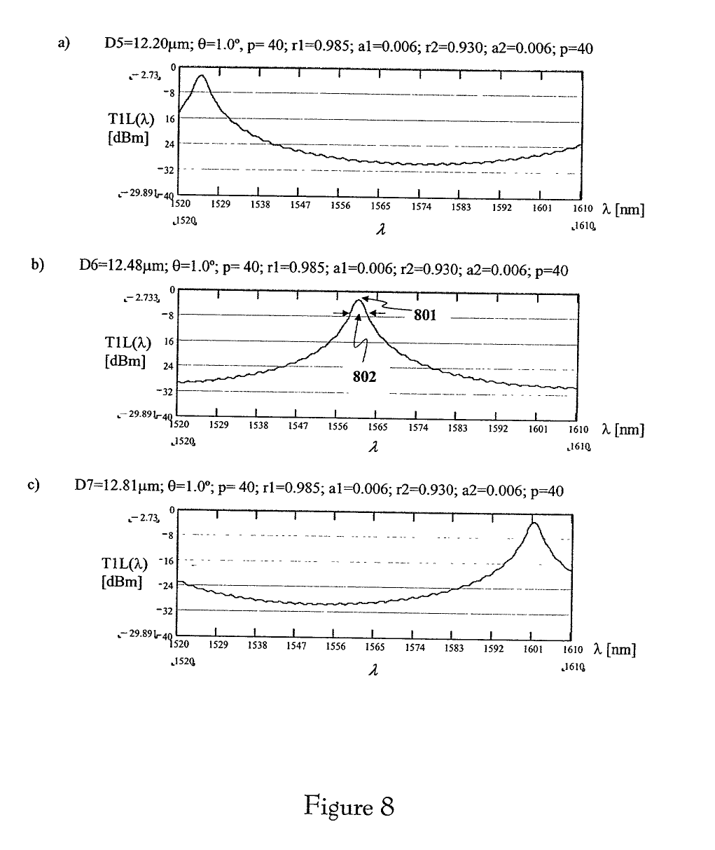

One of the preferred embodiments of this invention is a single-stage low-order TBPOF built with one TBPI having the gap D in μm's range. Its transmission function T1(λ), exemplary in nature, is shown in FIGS. 8a, 8b and 8c for the wavelength range 1520 nm to 1610 nm and has only one transmission peak 801 with constant amplitude (insertion loss) and constant bandwidth 802 in the specified wavelength range. The preferred embodiment of single-stage TBPOF shown in FIG. 2 and described herein and above achieves the gap D in μm's range by a coarse adjustment with the compensation screws 246 and 236, followed by a fine adjustment done by the piezo-ceramic actuator 245 under the action of the offset voltage Uofst. The voltage Utun makes the tuning of TBPI to a particular wavelength by finely adjusting D as it was explained herein and above, in connection to FIGS. 5a, 5b, FIGS. 6a and 6b. It can be seen from the graphs shown in FIGS. 8a, 8b and 8c that a variation ΔD of the gap D≈13 μm with about 0.6 μm will produce a shift in the center frequency of the pass band of the single-stage low-order TBPOF with about 70 nm. The above numbers are given only for exemplary purposes, TBPOF according to the present invention is capable of tuning range larger than the examples shown in FIGS. 8a, 8b and 8c, which are just showing the capability of the preferred embodiment to have only one maximum into a free spectral range of about 70 nm. According to the viewgraphs shown in FIGS. 8a, 8b and 8c, the single-stage low-order TBPOF has about 2.5 nm bandwidth at −3 dB and the slope of the transmission characteristic is about 2.6 dB/nm. The center wavelength of the filter can be set to any wavelength range such as 1550 nm, or 1310 nm with the offset voltage Uofst, 245, the wavelength can subsequently be tuned into an interval of about 100 nm using the tuning voltage Utun. Some applications such as coarse WDM (CDWM) that require about 20 nm channel spacing can use the preferred embodiment of the single-stage low-order TBPOF described above in connection with the assembly drawing shown in FIG. 2, having the transfer function T(λ) shown in FIGS. 8a, 8b and 8c.

Smaller channel separation required in DWDM systems requires better selectivity for channel spacing such as 0.8 nm (100 GHz ITU grid), 0.4 nm (50 GHz ITU grid) or even 0.2 nm (25 GHz ITU grid), which imposes conditions of steeper slopes of the transmission characteristic T(λ), than those shown in FIGS. 8a, 8b and 8c.

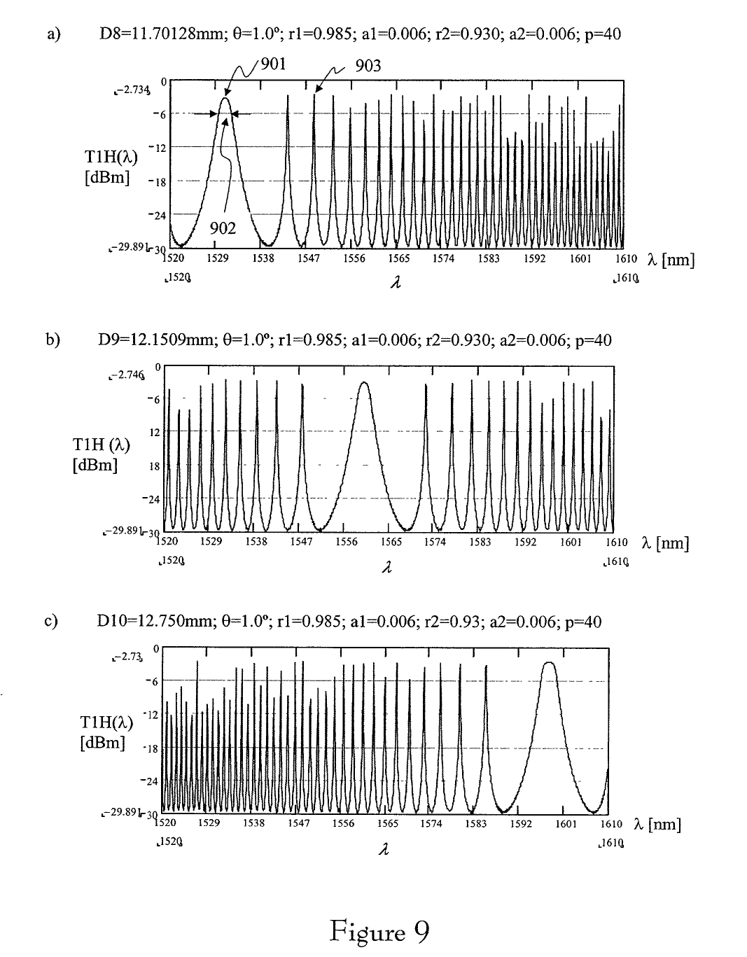

Another embodiment of this invention is single-stage high-order TBPOF. As described in the U.S. patent application Ser. No. 09/705,447, for certain values of gap D in mm's range, the transfer function T1H(λ) is shown in FIGS. 9a, 9b and 9c. It can be seen from these graphs that in the wavelength range between 1520 nm and 1610 nm considered as an example only, there is only one main peak 901 much larger than the other peaks. The peak 901 has constant amplitude (insertion loss) and constant bandwidth 902 of about 2.7 nm at −3 dB. There are also certain number of secondary maxima 902, much narrower (<0.2 nm) than the main peak, all these secondary maxima surround the main peak with decreasing spacing between them as they are located further apart from the main peak. These are considered spurious for this embodiment of the invention. This embodiment of the invention for single-stage high-order TBPOF is realized in the same manner and with the same elements as it was described above for low-order TBPOF, the only difference between high-order and low-order TBPI contained by TBPOF being the size of the gap D between the reflective layers 203 and 204, which is higher for high-order TBPI. As an example of the preferred embodiment of this invention for high-order single-stage TBPI is the situation when the gap D between the reflective layers changes with ΔD=1.049 mm, from D8=1.701 mm (FIG. 9a) to D10=12.750 mm (FIG. 9c), that produces a shift of the central wavelength of the main peak with about 77 nm. The examples shown in FIGS. 9a, 9b and 9c are exemplary in nature and do not restrict the capabilities of single-stage, high-order TBPOF to the wavelength range considered in this example.

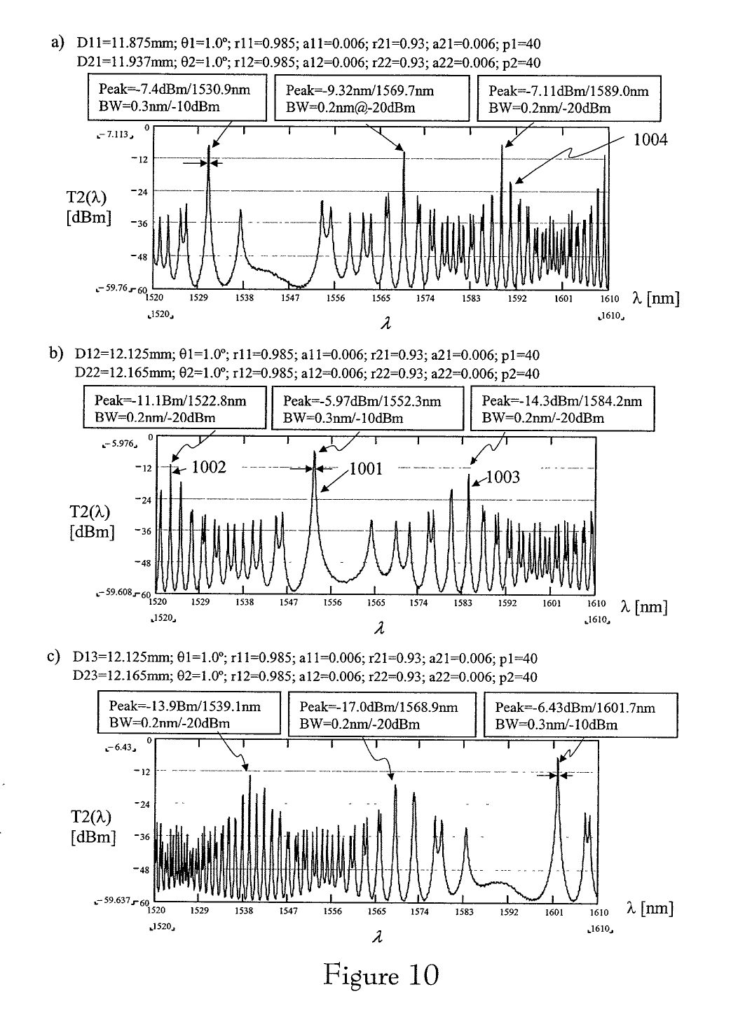

Another embodiment of this invention is a two-stage vernier TBPOF built with two single-stage high-order TBPI, cascaded optically according to vernier principle. The vernier tunable band pass optical filter uses only the main maximum 901 of the single-stage high-order TBPI for tunability purposes and rejects strongly the spurious maxima 903. This is accomplished by cascading optically two single-stage high-order TBPI having the center wavelengths slightly shifted by an amount such that the spurious maxima of the first TBPI must be as close as possible to the minima of the second TBPI. This cascading method being also known as the vernier method by those skilled in the art. Some exemplary graphs of the transmission characteristics T2(λ) of two-stage vernier TBPOF are shown in FIGS. 10a, 10b and 10c. The transmission function T2(λ) has also a main peak 1001 with constant amplitude (about −7.4 dBm) when it is shifted in the considered wavelength range, but with a much narrower bandwidth (about 0.3 nm at −10 dBm) than the main peak 901 of the single-stage high-order TBPI. The vernier cascading has also some spurious peaks such as 1002 and 1003 with significant high amplitudes (respectively −11.1 dBm and −14.3 dBm) and narrower bandwidth (about 0.2 nm at −20 dBm) that are spaced apart from the main peak with about 30 nm. The insertion loss of two-stage vernier TBPOF, given by the amplitude of the main peak 1001 is almost two times higher than the insertion loss of the single-stage TBPI, as it can be seen from FIGS. 10a, 10b and 10c, where TBPI of the cascade differ only by the size of gap D. If the vernier tunable band pass optical group is working within about 30 nm wavelength range, its selectivity for DWDM application is acceptable, as all the spurious peaks such as 1004 having low enough amplitudes to make a good rejection of the unwanted channels. The selection of the center wavelength of the main peak of each TBPI of the vernier cascade will be explained herein later.

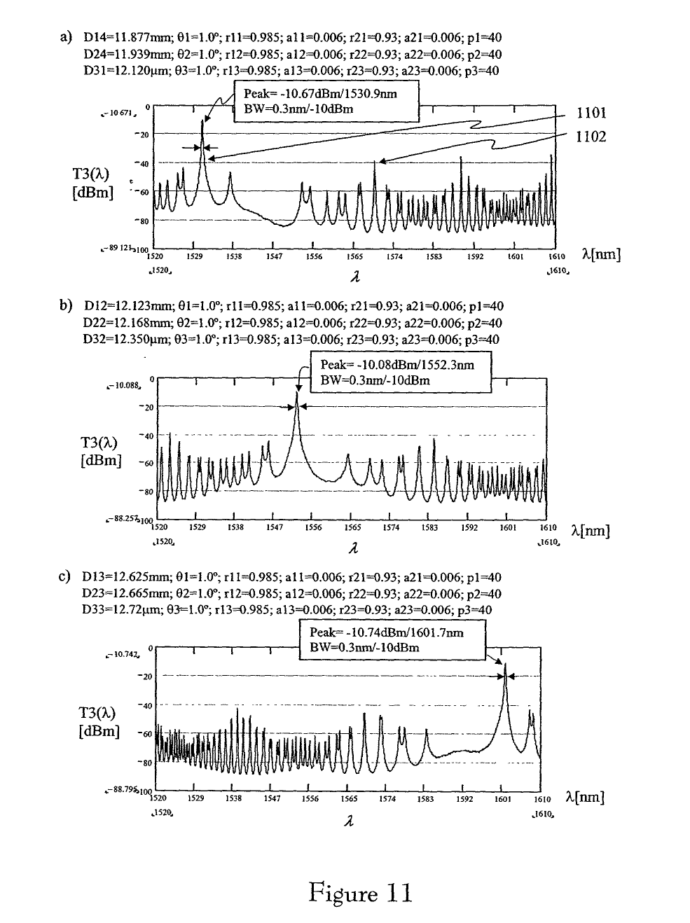

Another alternate embodiment of the present invention is a three-stage TBPOF with three TBPI, with two single-stage vernier-cascaded high-order TBPI, further cascaded with a single-stage low-order TBPI having its band pass centered on the main transmission peak of the previous vernier cascaded high-order TBPI. Some graphs of the transmission characteristic T3(λ) of this TBPOF are shown in FIGS. 11a, 11b and 11c, which are obtained for different values of the gap between the reflective layers: D_{1X} is for the first high-order TBPI, D_{2X} is for the second high-order TBPI and D_{3X} is for the third TBPI (low-order), where X denotes the current value of the gap D for each TBPI. FIGS. 11a, 11b and 11c show that the main maximum of the three-stage TBPOF has almost the same bandwidth (0.3 nm at −10 dBm) as the main maximum of the two-stage vernier TBPOF described herein and above, but with a higher insertion loss (about −10.7 dBm), introduced by the third TBPI. FIGS. 11a, 11b and 11c show also constant amplitude and bandwidth of the main peak 1101 of the three-stage TBPOF within the range from 1520 nm to 1610 nm, presented as an example only. The transmission characteristics T3(λ) shown in FIGS. 11a, 11b and 11c also have spurious peaks with different amplitudes, some of them such as 1102 being higher than the others, however, all spurious amplitudes are smaller than 1101, for example about 30 dBm, which is satisfactory for long haul DWDM applications.

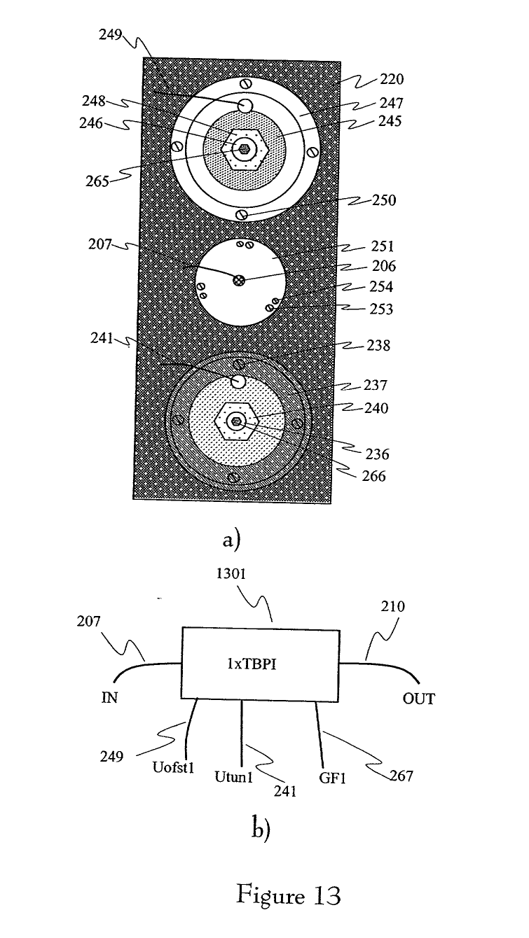

Some of the main elements of the preferred embodiment of single-stage TBPOF are summarized in FIG. 12a that is a view from direction A (FIG. 2) of this embodiment. For clarity purposes, the offset reflective sub-assembly 1201 (FIG. 3a and FIG. 12b) and the tuning reflective sub-assembly 1202 (FIG. 3b and FIG. 12c) are also shown nearby. FIG. 13a is a view from direction B (FIG. 2) of a single-stage TBPI, and FIG. 13b is a symbolic representation 1301 of a single-stage TBPI (labeled 1×TBPI), containing the input optical fiber 207, the output optical fiber 210, the terminal 241 for the tuning voltage Utun1, the terminal 249 for the offset voltage Uofst1 and the terminal 267 for the gap feedback GF1. This symbolic representation will be used further in the present description.

As it was explained herein and above, cascading two or more TBPI to build a TBPOF is required for some DWDM applications. The preferred embodiment of two-stage TBPOF contains two single-stage high-order vernier-cascaded TBPI, but some other embodiments such as both TBPI low-order, both TBPI high-order or high-order TBPI cascaded with a low-order TBPI are also possible embodiments, not excluding also other non-mentioned combinations.

Another alternate embodiment of this invention is a three-stage TBPOF containing two high-order TBPI cascaded with a third low-order TBPI that will be described herein below.

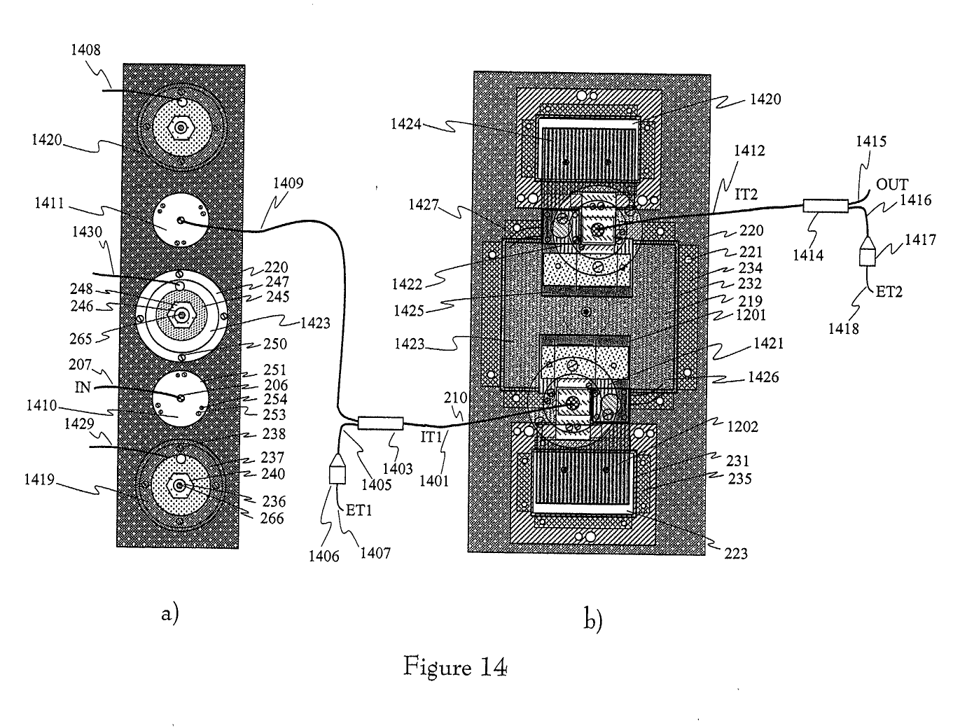

In this alternate embodiment a two-stage TBPOF has a cascade of two high order TBPI (2VHTBPI) according to the vernier principle. An exemplary configuration for this embodiment is shown in FIGS. 14a and 14b. The optical signal (IN) is entering into the first single-stage high-order TBPI through the optical fiber 207 that is the input optical port (FIG. 14a).

The first single-stage high-order TBPI of this embodiment of two-stage TBPOF is represented in FIGS. 14a and 14b by some of its main sub-assemblies describer further. The transmitting collimator sub-assembly 1410 has the input collimator holder 251, fiber optic transmitting collimator 206, input optical fiber 207, and the screws 253 and 254. TBPI has also the offset reflective subassembly 1201 (see also FIG. 3a), offset actuator sub-assembly 1423 with the offset translation plate 219 with flexures 232 and frame 234, the ball 243, pushing rod 244, piezo-actuator 245, compensation screw 246 with the recess 265, nut 248, and piezo-housing 247 (see also FIG. 2). TBPI still contains the tuning reflective assembly 1202 (see also FIG. 3b) and the tuning actuator 1419, comprising mainly of the translation plate 223, flexures 231, frame 235, ball 230, pushing rod 229, piezo-actuator 233, compensation screw 236 with the recess 266, nut 240, the piezo-cover 237 and piezo-housing 225 (see also FIG. 4b). The receiving collimator assembly 1421 comprises mainly of the receiving fiber optic collimator 209, output collimator holder 257 and the output fiber housing 261 (see also FIG. 2). This embodiment of the receiving collimator assembly 1421 is very similar with the embodiment of the transmitting collimator assembly 1410. The optical signal filtered by the first single-stage high-order TBPI is collected by the receiving collimator assembly 1421 as the optical signal 1401 (IT1) available at the output fiber 210, which is further spliced at the input of the low polarization fiber optic tap coupler 1403, such as model #44-10355-01-1120 with tap ratio about 1/99, made by Gould Fiber Optics.

The output of the fiber optic tap coupler 1403 is spliced further with the fiber 1409 that is the input optical port of the transmitting collimator assembly 1411 of the second TBPI. All the embodiments of this invention use only monomode optical fibers.

The fiber optic tap coupler 1403 has also the tapped output fiber 1405 fused to a pig-tailed photodiode 1406 that generates at its terminals 1407 a photo-detected signal ET1 (1407) that is proportional with the intensity IT1 (1401) of the optical signal at the output of the first TBPI. ET1 will be used to tune the first TBPI to a required wavelength, as it will be explained briefly herein below.

The second single-stage high-order TBPI of the preferred embodiment of two-stage TBPOF is built with the same assemblies as the first high-order TBPI, the only difference from the first TBPI being a slightly different values of the gap D between the reflective layers necessary to implement the vernier function described herein above. The second single-stage high-order TBPI uses the same base plate 220 and the same offset actuator assembly 1423 as the first TBPI to reject at common mode the vibrations and the gap drift for both cascaded TBPIs. The second single-stage high-order TBPI of this TBPOF does not share with the first TBPI the following sub-assemblies: transmitting collimator subassembly 1411 having identical construction with 1410, offset reflective sub-assembly 1425 having identical construction with 1201, tuning reflective assembly 1424 having identical construction with 1202, tuning actuator 1420 having identical construction with 1419 and the receiving collimator subassembly 1422 having identical construction with 1421. The optical signal collected by the output receiving collimator assembly 1422 is available at the output fiber 1412 of the second TBPI of this embodiment of two-stage TBPOF. The output fiber 1412 is spliced at the input of the fiber optic tap coupler 1414, which is identical in construction to 1403, and which delivers the output signal OUT of TBPOF at the output fiber 1415 and gives the sampled optical signal at the tapped output fiber 1416. The tapped output 1416 is pig-tailed with the photo diode 1417 that generates at its terminals 1418 a photo-detected signal ET2 that is proportional with the intensity IT2 of the optical signal at the output of the second TBPI of TBPOF. This method of tuning the TBPOF as described above consists of adjusting first the gap D1x of the first TBPI by using the feedback signal ET1 generated by the photodiode 1406, until the main peak 901 (FIG. 9a) is centered to the required wavelength. There is no ambiguity in this tuning because the main peak is much wider than all the other peaks such 902, FIG. 9a. The tuning method for the second TBPI is accomplished by adjusting the gap D2x using the feedback signal ET2, until the signal has a main peak 1001 (FIG. 10b) centered on the required wavelength. The tuning on the mean peak 1001 is easy to achieve, because its amplitude is significantly higher than the highest spurious peaks such as 1002 and 1003, also the main peak 1001 is wider than any spurious peaks.

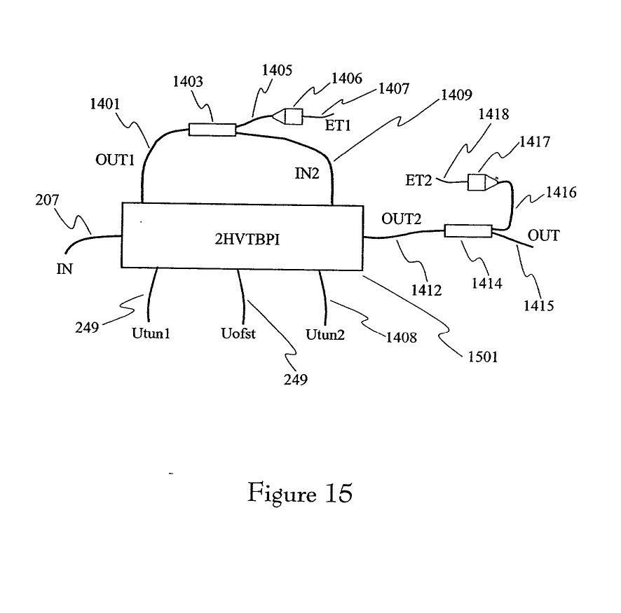

A symbolic representation of two-stage TBPOF built with two vernier-cascaded single-stage high-order TBPI (2VHTBPI) 1501 together with fiber optic tap couplers and photodiodes, are shown in FIG. 15, where the numbering of the elements is the same as it was used throughout the description herein above for the high-order vernier-cascaded TBPIs. IN is the optical signal at the input of two-stage TBPOF and OUT1 is the optical signal at the output of the first TBPI of the cascade, IN2 is the optical signal at the input of the second TBPI of the cascade, OUT2 is the optical signal at the output of the second TBPI and OUT is the optical signal available at the output of two-stage TBPOF. The preferred embodiment of this invention for two vernier-cascaded TBPI requires only one offset voltage 249, Uofst2, for both TBPI and two tuning voltages 249, Utun21 and 1408, Utun22. There are also two gap feedback signals GF1, 1426 and GF2, 1427 respectively proportional with the gap size of each tunable band pass interferometer.

Some applications such as DWDM can require that the main maximum 1001 (FIG. 10b) should be as narrow as is obtained by the embodiment of this invention for a two-stage TBPOF described herein above, however the spurious maxima like 1002 and 1003 (FIG. 10b) must have an amplitude much lower and with much wider wavelength separation than it is possible to achieve by vernier-cascading two single-stage high-order TBPI, as it was described in the preferred embodiment herein and above and is shown in FIGS. 11a, 11b and 11c. These drawbacks can be eliminated by another preferred embodiment of this invention that is a three-stage TBPOF, described herein and below.

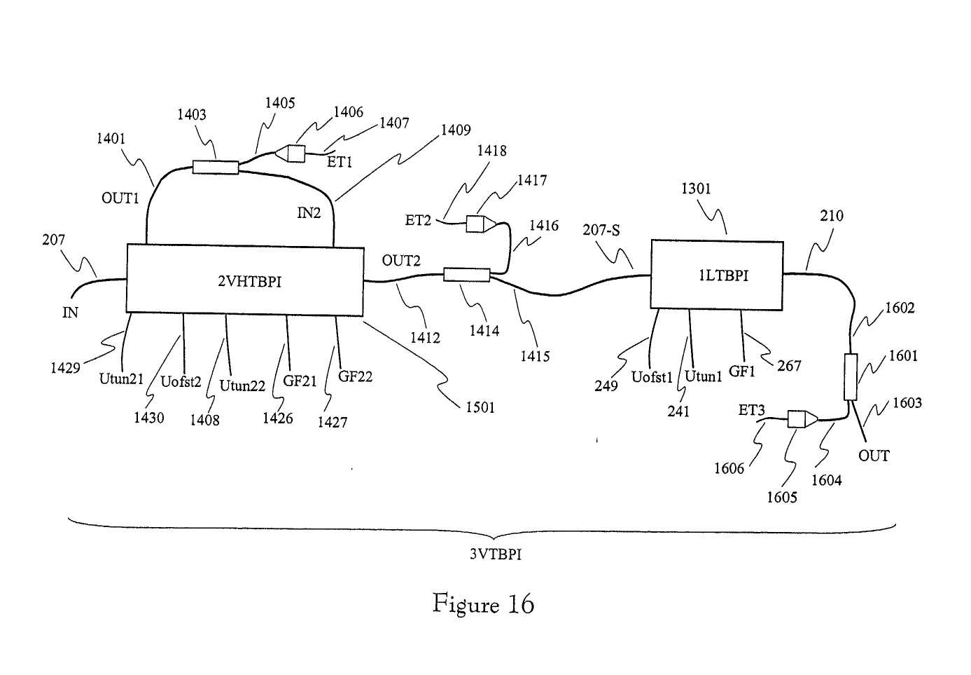

This alternate embodiment of this invention having a three-stage TBPOF comprises a cascade of three TBPI: two vernier-cascaded single-stage high-order TBPI, 1501, cascaded further with a single-stage low-order TBPI, 1301, the whole cascade being referred further as 3VTBPI, with the symbolic representation shown in FIG. 16. This cascading is realized by splicing the output fiber 1415 at the output of fiber optic taper 1414 with the input fiber 207-S of a single stage, low-order TBPI, 1301. The output fiber 210 of the single-stage low-order TBPI, 1301, is further spliced with the input fiber 1602 of the fiber optic taper 1601 that gives the output optical signal OUT of the three-stage 3VTBPI. The tapped output fiber 1604 is spliced with the pig-tailed photodiode 1605 that generates the electrical tapped signal ET3 at the terminals 1606. The tuning of three-cascaded TBPI on a specified wavelength is done sequentially. First the cascade 2VHTBPI 1501, is tuned as it was explained in principle herein above, followed by the tuning of TBPI, 1301, effected by adjusting the control voltages Uofst1 and Utun1 using also the signal ET3 proportional with the optical output signal OUT as an intensity feedback signal, in order to achieve the transfer characteristics of the filter similar to those shown in FIGS. 11a, 11b and 11c, for any specified wavelength. The description of the tuning procedure for the three-cascaded TBPI given above, according to the preferred embodiment of this invention is only an exemplary description.

All embodiments of TBPOF, contain a TBPOF controller 1701 that manages the operation of the whole tunable filter as a system, which is shown symbolically in FIG. 17. The exemplary operation of TBPOF controller will be further described in connection with FIG. 17. TBPOF controller 1701 handles the operation of each individual TBPI of the cascade and also the operation of the whole cascade. In this embodiment of the invention, the controller 1701 receives the information about the tuning wavelength from the optical network monitoring system ONMS, 1704, by the external command bus EXT_COM, 1702. In DWDM applications, the optical input signal IN, 207, (FIG. 17) has a multitude of wavelengths. After receiving the command for tuning to a particular wavelength, TBPOF controller 1701 generates the signal Uofst2, 1430, to drive the offset piezo-actuator of the two vernier-cascaded connection 2VHBPI to coarsely adjust the gaps of its TBPIs within the range of the required wavelength. Uofst2 is generated by 1701 into a closed loop that has as feedback the signals GF21, 1426 and GF22, 1427 coming from the position sensors of the gaps, and also at the values of GF21, GF22 for that particular wavelength, stored into a non-volatile memory during a calibration procedure. During the process of approaching the gaps of vernier-cascaded TBPI close to their pre-determined values, the controller 1701 is in wavelength search mode, with the control loop for the piezo driving voltages using as feedback only the signals GF21 and GF22 generated by the gap position sensors of TBPI. As soon as the error between the current values of GF21, GF22 signals and their stored values is within a certain range, the controller 1701 enters into the wavelength lock mode, when it is looking also at the signals ET1, 1407 and ET2, 1418 generated by the beam sampling group 1403, connected with photodiode 1406 and by the sampling group 1414, connected with photodiode 1417, to finely adjust the gaps of TBPI to maximize the photo detected signals ET1 and ET2 in order to select the main maximum as it was explained herein above with respect to the description of the two-stage TBPI. The loop for wavelength lock mode is always within the loop of wavelength search mode in order to keep the mechanical stability of the system. When entering into wavelength lock mode for TBPOF, 1501, 2VHTBPI, the controller 1701 sends back to the optical network monitoring system 1704 an acknowledge signal LK2_ACK on the lines 1703 informing about the existence of the required wavelength at the optical input IN, 207, and information about the tuning of the first two TBPI on that wavelength. In wavelength lock mode, the TBPOF controller also constantly monitors the gaps of both TBPI in order to keep the optical signal OUT2, 1412, at the output of the first cascade 2VHTBPI, 1501, on its maximum value. The tuning procedure of two-stage TBPOF made of two single-stage vernier-cascaded TBPI described herein and above is very similar with the tuning procedure when 1501 contains only one-stage TBPI. For a single-stage TBPI, there is one tuning voltage Utun1 and one feedback signal from the mirror gap GF1. When it is in wavelength tuning mode, the controller 1701 can execute also wavelength tracking, if this function is required by the optical network monitoring system, through one of the instructions coming on the EXT_COM bus 1702. In wavelength tracking mode, the central tuning wavelength of the filter will follow the selected wavelength at the input IN, 207, even if this wavelength has a drift. In wavelength lock mode, TBPOF can also track its transmission maximum to follow the eventual wavelength changes induced by chromatic dispersion (CD) and polarization mode dispersion (PMD) during the propagation of the optical signal in optical fiber. If the amplitude of ET1 and ET2 signals are below the threshold level when the gap between the reflective layers is within the range measured with the position sensors by the end of the wavelength search mode, TBPOF controller 1701 sends back to the optical network monitoring system ONMS, 1704 an acknowledge signal LA_ACK on the lines 1703 indicating that the amplitude of the required wavelength at the optical input IN 207, is not at the predetermined value. At this point, TBPOF controller 1701 does not proceed further into the wavelength lock mode and waits for other commands from ONMS, 1704. TBPOF controller 1701 makes a distinction between the main maximum and the secondary maxima (FIGS. 9a, 9b and 9c, and FIGS. 10a, 10b and 10c) by associating the current amplitudes of the signals ET1, 1407, and ET2, 1418, with the values of the gap signals GF21, and GF2, at which the main maxima are expected to occur. If TBPOF contains also a low-order TBPI, 1301 as is shown in FIG. 17 to achieve the optical filtering characteristics as is shown in FIGS. 11a, 11b and 11c, after the tuning of 1501 to the required wavelength, TBPOF controller 1701 proceeds further to tune the low-order TBPI, 1301. To do this, TBPOF controller is set first to wavelength search mode for 1301 using the feedback signal GF1 generated by its position sensor on line 267. Subsequently, when GF1 is within the expected range for the required wavelength, TBPOF controller enters into wavelength lock mode using the beam intensity feedback signal ET3. TBPOF controller 1701 considers TBPOF according to the preferred embodiment of this invention, tuned to the required wavelength, when the main peak 1101 (FIG. 11a) is reached, that happens when all the beam intensity signals ET1, ET2 and ET3 have their maxima above a predetermined value. At that moment, TBPOF is locked to the required wavelength and the controller 1701 sends the acknowledge signal LK3 ACK on line 1703, informing ONMS, 1704 about the tuning of three-stage TBPOF to the required wavelength. At this moment, if there is a command for wavelength tracking, three-stage TBPOF can also enter into wavelength tracking mode as it does for two-stage TBPOF, to follow the eventual wavelength changes induced by chromatic dispersion (CD) and polarization mode dispersion (PMD) during the propagation of the optical signal in optical fiber.

Having now described one or more preferred embodiments of the invention, it should be apparent to those skilled in the art that the foregoing is illustrative only and not limiting, having being presented by way of example only. All the features disclosed in this specification (including any accompanying claims, abstract and drawings) may be replaced by alternative features serving the same purpose, equivalents or similar purpose, unless expressly stated otherwise. Therefore, numerous other embodiments of the modifications thereof are contemplated as falling within the scope of the present invention as defined by appended claims and equivalents thereto.

What I claim is:

1) A tunable band pass optical filter comprising:
a frame;
at least one translation plate;
at least one flexure element for mounting said at least one translation plate to said frame;
a first mirror mounted to said at least one translation plate;
a second mirror mounted to said frame in optical communication with said first mirror, having a distance between said first and said second mirror;
at least one compensation screw operatively connected to said frame and said at least one translation plate; and
at least one piezo-ceramic actuator operatively connected to said frame and said at least one translation plate.

2) The tunable band pass optical filter of claim 1 wherein said at least one translation plate includes a second translation plate; wherein said at least one flexure element includes a second flexure element for mounting said second translation plate to said frame; and
wherein said second mirror is mounted to said second translation plate.

3) The tunable band pass optical filter of claim 2 wherein said at least one compensation screw includes a second compensation screw.

4) The tunable band pass optical filter of claim 2 wherein said at least one piezo-ceramic actuator includes a second piezo-ceramic actuator.

5) The tunable band pass optical filter of claim 1 further including a spherical element interposed between said at least one piezo-ceramic actuator and said at least one translation plate.

6) The tunable band pass optical filter of claim 4 further including a spherical element interposed between said at least one piezo-ceramic actuator and said at least one translation plate.

7) The tunable band pass optical filter of claim 1 further including a position sensor operatively connected to said at least one translation plate.

8) The tunable band pass optical filter of claim 7 wherein said position sensor operates in a closed-loop system for adjusting said distance.

9) A tunable band pass optical filter of claim 1, further including a light input port and a light output port.

10) A tunable band pass optical filter of claim 9, further including a light source.

11) A tunable band pass optical filter of claim 9, further including at least one light collector.

12) A tunable band pass optical filter of claim 11, wherein said at least one light collector includes a fiber optic tap coupler in optical alignment with said first and said second mirror.

13) A tunable band pass optical filter of claim 12, further including a photodiode operatively connected to said fiber optic tap coupler.

14) A tunable band pass optical filter of claim 10, further including a light collimator operatively coupled to said light source and said input port.

15) A tunable band pass optical filter of claim 10, wherein said light collimator is a monomode fiber.

16) A tunable band pass optical filter of claim 8 wherein said closed-loop system includes a controller for actuating said at least one piezo-ceramic actuator.
